(19) United States
(12) Patent Application Publication
(10) Pub. No.: US 2010/0022223 A1
(43) Pub. Date: Jan. 28, 2010

(54) Method and apparatus for producing a map for mobile reception at each cell tower

(76) Inventors: Jeffrey Lynn Taylor, Rushville, IN (US); Ronald Lynn Blair, Liverpool, NY (US)

Correspondence Address: Robert D. Shedd, Patent Operations;THOMSON Licensing LLC, P.O. Box 5312, Princeton, NJ, 08543-5312, US

(21) Appl. No.: 12/311,727

(22) PCT Filed: Oct. 31, 2006
(86) PCT No.: PCT/US06/42352

§ 371 Date: Apr. 9, 2009

(51) Int. Cl. H04M 3/42; H04W 24/00

(52) U.S. Cl. 455/414.1; 455/456.1

(57) ABSTRACT

A method and apparatus for producing a video map for mobile reception, comprising generating the video map of an area having points of interest proximate to a cell tower and transmitting the video map over a dedicated channel, are described. Also described are a method and system for receiving a video map for mobile reception, comprising tuning to a dedicated channel and receiving the video map over the dedicated channel. Finally a method and apparatus for determining a location with respect to a point of interest, comprising receiving a video map over a dedicated channel, superimposing a moving jpeg image onto the video map and tracking vehicle movement on the video map.

### FIELD OF THE INVENTION

The present invention relates to video maps of the area around a cell tower on a dedicated map channel.

### BACKGROUND OF THE INVENTION

The only way to determine what establishments are along a highway, for example is by the exit signs along a highway, which do not cover all establishments at the exit and the signs are usually so close to the exit that an informed decision cannot be safely made. The same is true of city streets, especially in an unfamiliar city or area.

### SUMMARY OF THE INVENTION

When traveling through an area, a person may need directions to certain locations or just want stop and eat or fill up the gas tank. The present invention provides a channel for video reception to either a hand held cell phone or an internet protocol set-top box (IP-STB) connected to a cell modem in an automobile. The channel provides a location of the cell tower and the areas of interest around that cell tower. The map channel would always be the same so the map would be displayed during cell changes, although the map may alter for the new tower. The points or locations of interest may include restaurants, gas stations, rest areas (welcome centers), museums, hotels/motels, malls, points of interest, shops etc. The area through which a person is traveling may be a city, a town or any other area.

The map can be tailored to limit the information provided. For example, a key entry or menu selection can provide just restaurants or just museums so that a video map of a congested area is more easily readable. The map can be further tailored within a category. For example, once the category “gas stations” is selected, the user can select from among the major brands or “other” which can include the brands not as well known. Similarly, with restaurants, the sub-categories can include “chains”, “ethnic”, “local” etc. This would be particularly helpful in a city or very congested area to make the video map more readable/usable. In a rural area or along a highway all points of interest could be displayed.

A method and apparatus for producing a video map for mobile reception, comprising generating the video map of an area having points of interest proximate to a cell tower and repeatedly transmitting the video map over a dedicated channel, are described. Also described are a method and system for receiving a video map for mobile reception, comprising tuning to a dedicated channel and receiving the video map over the dedicated channel. Finally a method and apparatus for determining a location with respect to a point of interest, comprising receiving a video map over a dedicated channel, superimposing a moving jpeg image onto the video map and tracking vehicle movement on the video map.

### BRIEF DESCRIPTION OF THE DRAWINGS

The present invention is best understood from the following detailed description when read in conjunction with the accompanying drawings. The drawings include the following figures briefly described below:

FIG. 1 is a block diagram of the system for providing a video map in accordance with the principles of the present invention.

FIG. 2a is a flowchart of the operations at an embodiment of the PC/processor.

FIG. 2b is a flowchart of the operations corresponding to FIG. 2a at the vehicle.

FIG. 3a is a flowchart of the operations at another embodiment of the PC/processor.

FIG. 3b is a flowchart of the operations corresponding to FIG. 3a at the vehicle.

FIG. 4a is a flowchart of the operations at yet another embodiment of the PC/processor.

FIG. 4b is a flowchart of the operations corresponding to FIG. 4a at the vehicle.

### DETAILED DESCRIPTION OF THE PREFERRED EMBODIMENTS

The present invention provides a video map of the area for each cell tower over a dedicated channel. Items or points of interest included on the map can be restaurants, gas stations, shops, malls, museums, hotels/motels etc. along with the normal roads and train tracks. The costs for providing the video map and the dedicated channel could be offset by points of interest paying for their establishments to be included on the map. The video map is at the cell tower coverage area of approximately 10 miles.

The video map is produced with any of a number of drawing programs, such as Visio. A video map is produced of the area surrounding a cell tower. The map is then saved as a jpeg image (or a motion jpeg). The image is then placed on a computer located at the cell tower base. The image is displayed repeatedly as a MPEG-2 video inside a MPEG-2 transport stream. The MPEG2 TS is then encapsulated in an Internet Protocol (IP) stream and sent on a dedicated known multicast/broadcast channel. The IP stream is sent to a Cellular digital subscriber line (DSL) modem for transfer to the cellular frequencies and by the appropriate signaling method (time division multiple access (TDMA), code division multiple access (CDMA), global system for mobile communications (GSM), Coded Orthogonal Frequency Division Multiplexing (COFDM), etc.). The mobile device can then receive the IP stream and decode it via the IP-STB in the automobile (or on the hand held cell phone) to be displayed on the mobile device display unit.

The map can include all establishments around the cell tower or the video map can be tailored by the user to display only certain categories of points of interest. The video map can be tailored by category (restaurants, hotel/motel, gas stations, museums, etc.) and within a category by subcategory. Multiple video maps can be transmitted from each cell tower and subcategory video maps can be called/requested by a plurality of user interface methods, including, for example use of another channel or mouse click on a menu or a combination of key strokes on a key pad, etc.

In another embodiment the map can be an HTML page sent to the IP-STB via the multicast channel. The IP-STB then superimposes a moving jpeg image of the current position onto the HTML map. The moving jpeg then tracks the movement of the car via either triangulation using the SNR ratios of cell towers (location of cell towers for triangulation can be sent in the HTML page) or using the GPS link of mobile receivers. If the user's cell phone has IP technology, such as blue tooth, the cell phone can link to the multicast channel and the need for the IP-STB goes away.

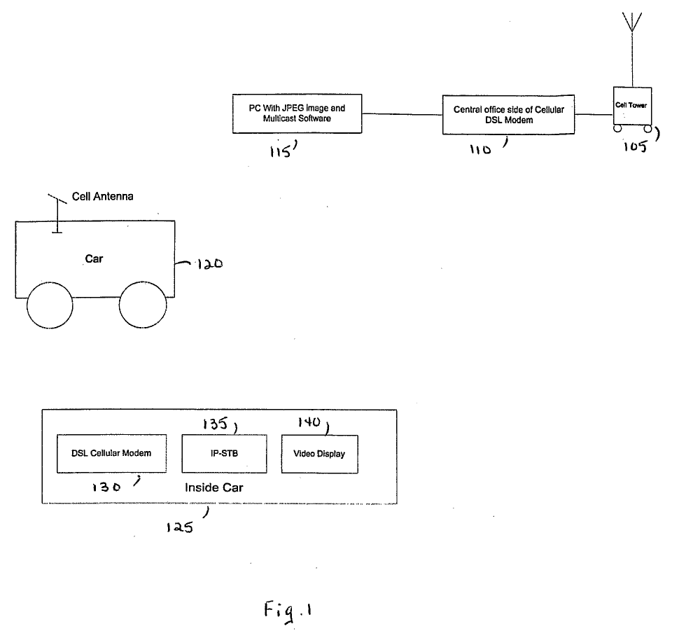

Referring to FIG. 1, cell tower 105 is in communication with the central office side of a cellular DSL modem 110, which is in communication with a personal computer (PC)/processor 115 that stores the video map as a JPEG, motion JPEG, or HTML image, which is multicast repeatedly. Multicasting a video map repeatedly is also intended to mean that a plurality of video maps (category and subcategory video maps) can also be multicast repeatedly. In the alternative embodiment, the category and subcategory video maps can be transmitted over a separate dedicated channel. The category and subcategory video maps are also stored in the PC/processor or can be generated in response to user's commands at and by the PC/processor.

The processor can be at located proximate to either the cell tower or at the central office. If the processor is proximate to the cell tower, it only has to produce the maps for that tower and the communications are quicker since a relay to the central office is not needed. If the processor is at the central office for all cell towers, the cell tower tag must be relayed to the central office for the map to be transmitted. A delay for the updates would be incurred since the requests (channel changes) must be sent back to the central office. This is not a long delay, but it is still a delay. The normal delay for a channel change can be up to 2 seconds (depending on how well the MPEG images are coded). This would add a possible extra 0.5 seconds (more depending on cell switching traffic handed at the central office).

A vehicle 120 travel through the cell tunes to the dedicated video map channel in order to receive a video map for that cell. In the embodiment depicted in FIG. 1, there is a display inside the vehicle 125 that includes a DSL cellular modem 130, an IP-STB 135 and a video display 140. DSL cellular modem 130 receives the video map data transmitted by the PC/processor 115 from the cell antenna of the vehicle 120. The video map data is demodulated by the DSL cellular modem 130 and provided to the IP-STB 135 for display on video display 140. The video map data is the general video map including all points of interest located within a radius of the cell or category video map data or subcategory video map data selected in response to a user command.

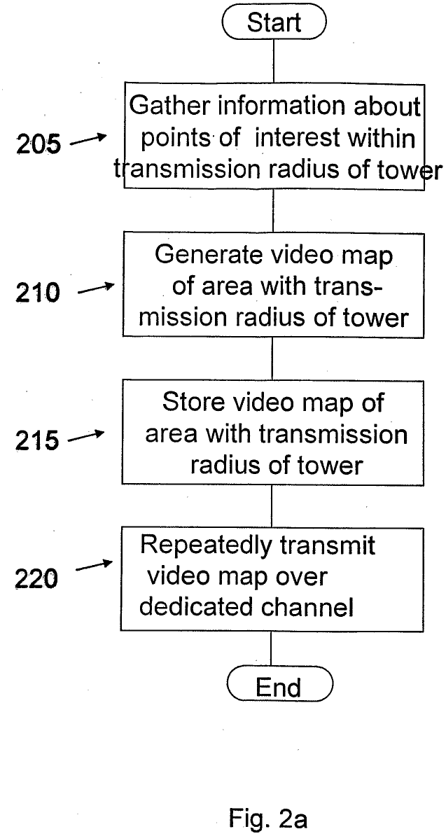

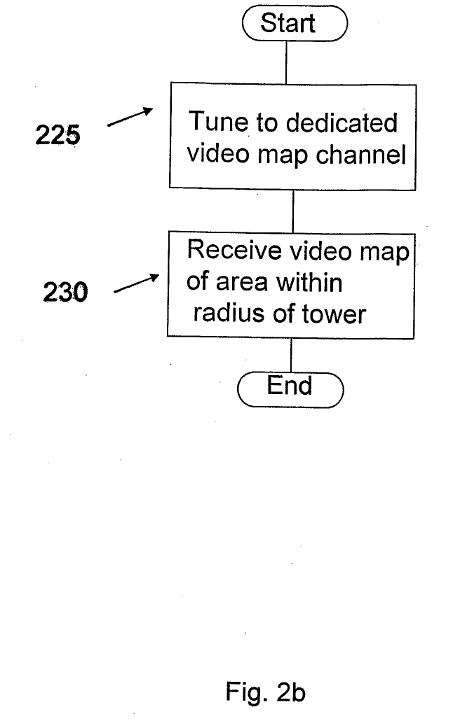

FIG. 2a is a flowchart of the operations at an embodiment of the PC/processor. Information is gathered/collected/input about the points of interest within a radius of a cell tower at 205. Video maps are generated of the area within a radius of the cell tower at 210. Video maps includes category and subcategory of video maps. The video maps are stored at 215 and repeatedly transmitted over a dedicated channel at 220. Transmission is effected by forwarding the video map information to the cell tower from which it is multicast using an appropriate signaling method.

FIG. 2b is a flowchart of the operations corresponding to FIG. 2a at the vehicle. The DSL cellular modem is tuned to the dedicated video map channel at 225. The video map is received at 230. Category and subcategory video maps may be received over separate dedicated channels.

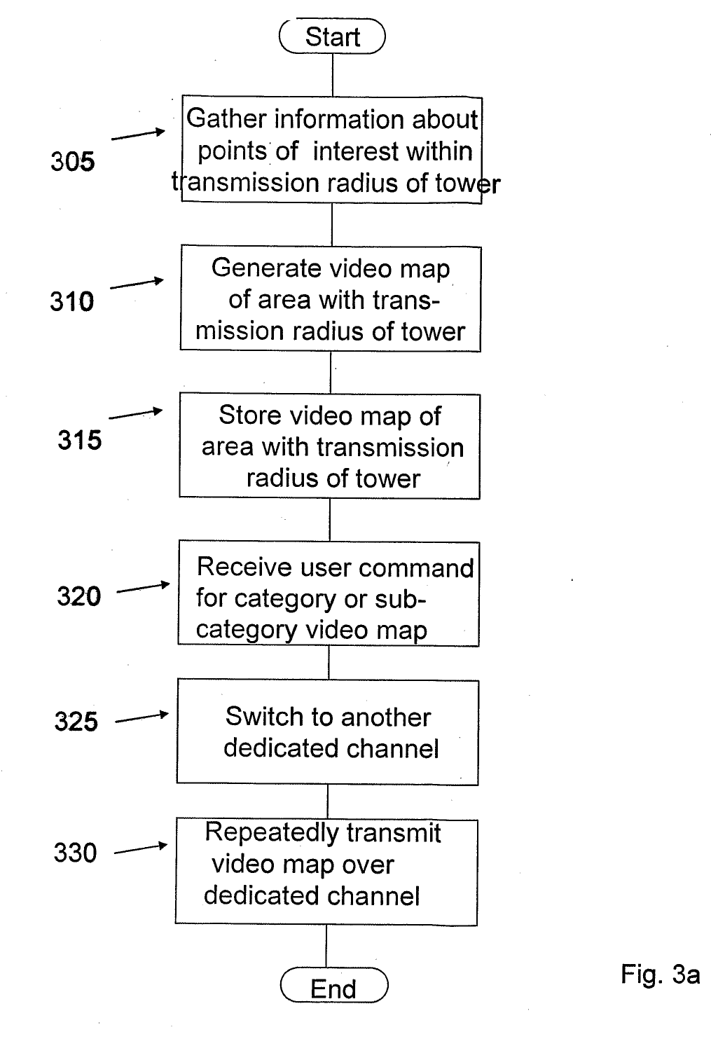

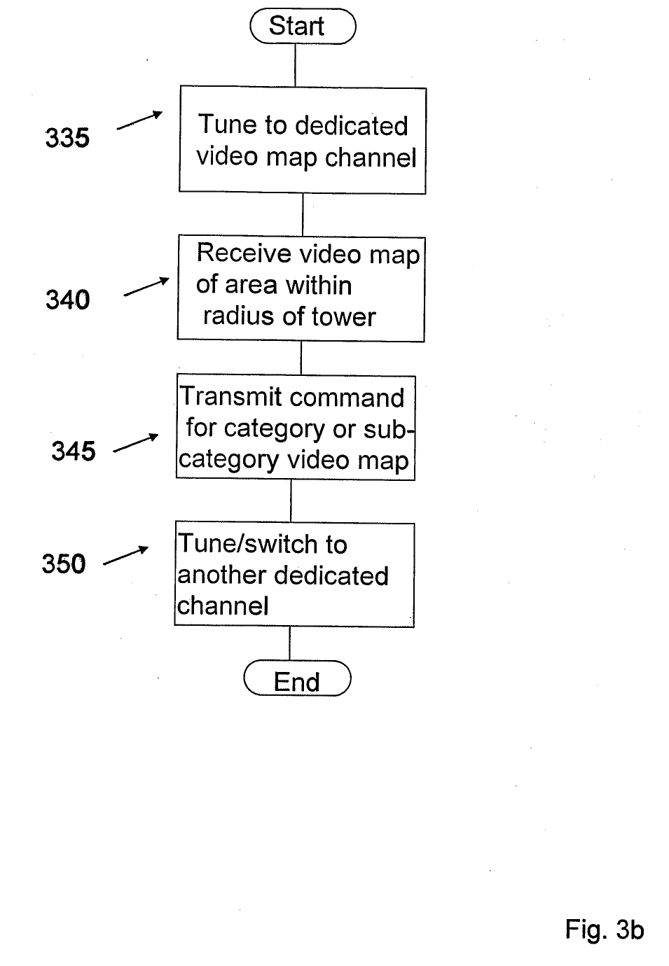

FIG. 3a is a flowchart of the operations at another embodiment of the PC/processor. Information is gathered/collected/input about the points of interest within a radius of a cell tower at 305. Video maps are generated of the area within a radius of the cell tower at 310. Video maps include category and subcategory of video maps. The video maps are stored at 315. A user command for a category or subcategory video map is received at 320. Another transmission channel is selected and switched to at 325. The stored video category or subcategory maps are transmitted repeatedly over the selected dedicated channel at 330.

FIG. 3b is a flowchart of the operations corresponding to FIG. 3a at the vehicle. The DSL cellular modem is tuned to the dedicated video map channel at 335. The video map is received at 340. Category and subcategory video maps may be received over separate dedicated channels. The DSL cellular modem transmits a user command/message requesting a video category or subcategory map at 345. The DSL cellular modem in the vehicle tunes to another dedicated channel in order to receive the selected video category or subcategory map at 350.

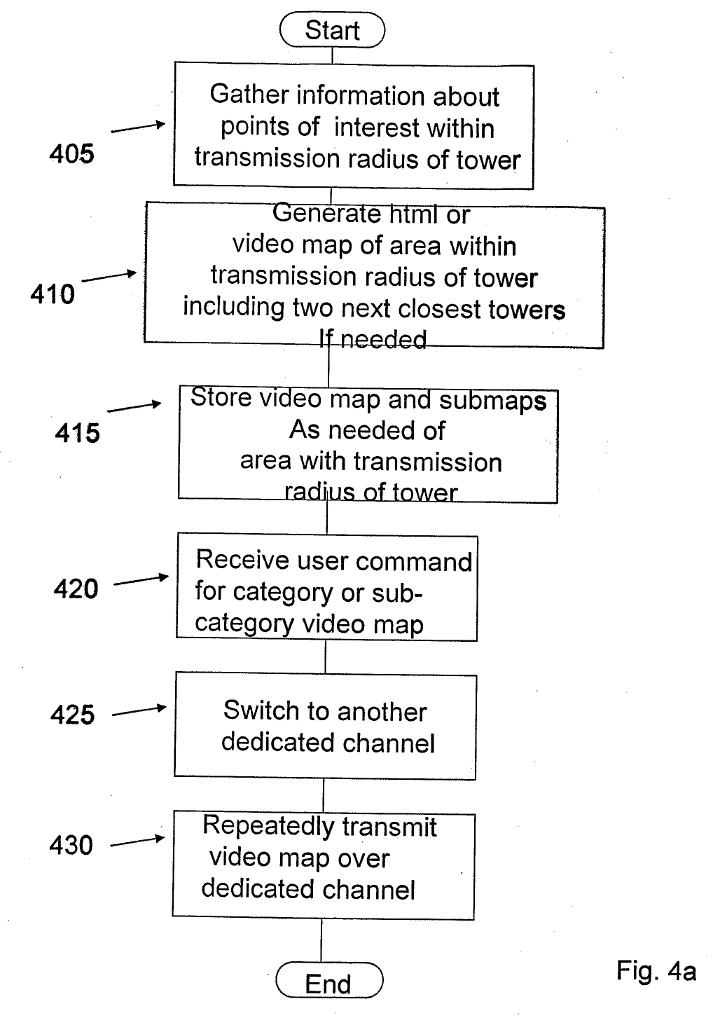

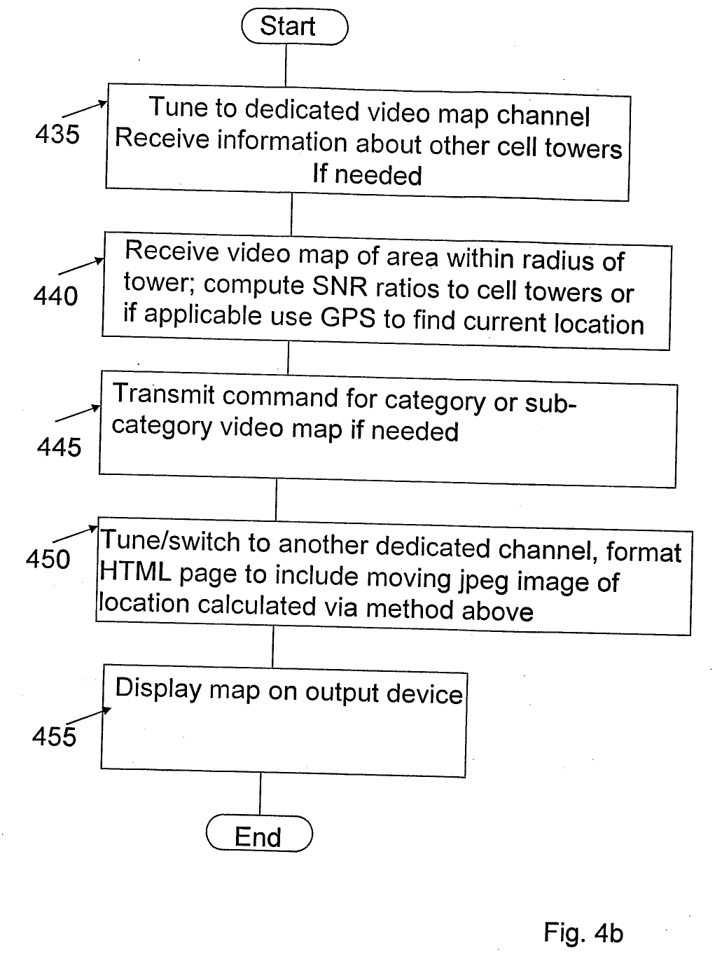

FIG. 4a is a flowchart of the operations at yet another embodiment of the PC/processor. Information is gathered/collected/input about the points of interest within a radius of a cell tower at 405. Video maps or html maps are generated of the area within a radius of the cell tower including the two next close cell towers if needed at 410. Video maps include category and subcategory of video maps. The video maps and category or subcategory maps are stored at 415. A user command for a category or subcategory video map is received at 420. Another transmission channel is selected and switched to at 425. The stored video category or subcategory maps are transmitted repeatedly over the selected dedicated channel at 430.

FIG. 4b is a flowchart of the operations corresponding to FIG. 4a at the vehicle. The DSL cellular modem is tuned to the dedicated video map channel at 435. Information is received about other cell towers if needed. The video map is received and signal-to-noise ratios (SNR) of the cell towers are computed at 440. If applicable a GPS is used to find the current location. Category and subcategory video maps may be received over separate dedicated channels. The DSL cellular modem transmits a user command/message requesting a video category or subcategory map at 445. The DSL cellular modem in the vehicle tunes to another dedicated channel in order to receive the selected video category or subcategory map and format the html page to include a moving jpeg image of the location calculated at 450. The map is displayed on an output/display device at 455.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method of producing a video map for mobile reception, said method comprising:
generating said video map of an area having points of interest proximate to a cell tower; and
transmitting said video map over a dedicated channel.

2. The method according to claim 1, wherein said video map includes one of a category and a subcategory of said video map.

3. The method according to claim 1, further comprising collecting information regarding said points of interest proximate to said cell tower.

4. The method according to claim 1, further comprising storing said video map.

5. The method according to claim 2, further comprising:
receiving a user command requesting one of said category and said subcategory of said video map; and
switching to another dedicated channel in order to transmit said requested one of said category and said subcategory of said video map.

6. The method according to claim 1, wherein said dedicated channel is multicast.

7. A method for receiving a video map for mobile reception, said method comprising:
tuning to a dedicated channel; and
receiving said video map over said dedicated channel.

8. The method according to claim 7, further comprising:
transmitting a request for one of a category and a subcategory of said video map; and
tuning to another dedicated channel in order to receive said requested one of said category and said subcategory of said video map.

9. The method according to claim 7, wherein said dedicated channel is multicast.

10. A system of producing a video map for mobile reception, comprising:
means for generating said video map of an area having points of interest proximate to a cell tower; and
means for transmitting said video map over a dedicated channel.

11. The system according to claim 10, wherein said video map includes one of a category and a subcategory of said video map.

12. The system according to claim 10, further comprising means for collecting information regarding said points of interest proximate to said cell tower.

13. The system according to claim 10, further comprising means for storing said video map.

14. The system according to claim 11, further comprising:
means for receiving a user command requesting one of said category and said subcategory of said video map; and
means for switching to another dedicated channel in order to transmit said requested one of said category and said subcategory of said video map.

15. An apparatus for receiving a video map for mobile reception, comprising:
means for tuning to a dedicated channel; and
means for receiving said video map over said dedicated channel.

16. The apparatus according to claim 15, further comprising:
means for transmitting a request for one of a category and a subcategory of said video map; and
means for tuning to another dedicated channel in order to receive said requested one of said category and said subcategory of said video map.

17. The apparatus according to claim 16, wherein said means for tuning and said means for receiving are an internet set top box.

18. A method for determining a location with respect to a point of interest, said method comprising:
receiving a video map over a dedicated channel;
superimposing a moving jpeg image onto said video map; and
tracking vehicle movement on said video map.

19. The method according to claim 18, wherein said video map is received as a browser page.

20. The method according to claim 18, wherein said movement tracking is via triangulation using signal-to-noise ratios of cell towers.

21. The method according to claim 18, wherein said movement tracking is via a global positioning system link of a mobile receiver.

22. An apparatus for determining a location with respect to a point of interest, comprising:
means for receiving a video map over a dedicated channel;
means for superimposing a moving jpeg image onto said video map; and
means for tracking vehicle movement on said video map.
